(19) United States
(12) Patent Application Publication
(10) Pub. No.: US 2009/0038341 A1
(43) Pub. Date: Feb. 12, 2009

(54) Round brilliant cut diamond and its incision method

(76) Inventor: Xiben Zheng, Guangdong (CN)

Correspondence Address: DAVID AND RAYMOND PATENT FIRM, 108 N. YNEZ AVE., SUITE 128, MONTEREY PARK, CA, 91754, US

(21) Appl. No.: 10/571,573

(22) PCT Filed: Sep. 9, 2004
(86) PCT No.: PCT/CN2004/001036

§ 371 Date: Jul. 7, 2008

(30) Foreign Application Priority Data
Sep. 12, 2003 (CN) 03158132.3
Apr. 8, 2004 (CN) 200410033434.8

(51) Int. Cl. A44C 17/00; B28D 5/00

(52) U.S. Cl. 63/32; 125/30.01

(57) ABSTRACT

The present invention discloses a round brilliant cut diamond. The diamond includes a crown, a girdle, and a pavilion, the cut crown includes one regular octagon table, eight first facets, eight second facets, and sixteen third facets, wherein the cut pavilion has sixteen quadrangular fourth facets, sixteen quadrangular fifth facets, and sixteen sub-triangular sixth facets. The sixteen fourth facets meet at a point, which forms an apex, and each fourth facet, fifth facet and sixth facet meet a point. The present invention also discloses methods for preparing above mentioned round brilliant-cut diamond.

### BACKGROUND OF THE PRESENT INVENTION

1. Field of Invention

The present invention relates to diamond cutting method, and more particularly, relates to a kind of round brilliant cut diamond as well as the method for preparing thereof.

2. Description of Related Arts

Round brilliant cut diamond, also known as standard brilliant cut diamond, is the hottest style available in current market. Ordinarily, a standard round brilliant-cut diamond comprises a crown portion, a girdle portion and a pavilion portion for defining total 57 facets thereon, wherein the crown portion has a table facet and three set of crown facets with a total of 33 facets, the pavilion portion has two set of pavilion facets with a total of 24 facets. Actually, the girdle portion is embodied as a cylinder shape. The reason why such type of diamond is referred as round brilliant diamond could be attributed to such cylinder shape girdle portion. That is to say, the cross section of the girdle of the diamond is round shape. As shown in FIG. 1, FIG. 2 and FIG. 3, a round brilliant-cut diamond comprises a crown portion 91, a girdle portion 92 and a pavilion portion 93 for defining 57 facets, wherein the crown portion 91 has a octagonal table facet, eight first facets 912, eight second facets 913, sixteen third facets 914, eight fourth facets provided onto the pavilion portion 92, and sixteen fifth facets 932.

The brilliancy, dispersion and flickering of the diamond are varied by its cut. That is to say, the quality of the diamond is not only determined by its intrinsic property, such as the size of the raw stone, the light reflection rate and so on, but also depended on the cutting craftwork. In other words, the brilliancy and dispersion of the diamond is achieved by cutting the diamond into a plurality of evenly distributed facets. The size and shape of such facets will be the key factor attributed to a fine diamond. A well defined cut will increase the visual-perceptible reflection of light ray thus improving the brilliancy whenever such diamond is observed by a user. It is therefore seen stricter orders and procedures have been introduced within the art instructing people to cut the diamond.

However, the conventional 57 facets cutting method is not desirable for preparing a relatively larger raw stone. The brilliance and flickering effect would be look inanimate and uncharacteristic. On the other hand, the arrangement and orienting angle setting of the facets are also important to achieve desirable physical reflection rays.

### SUMMARY OF THE PRESENT INVENTION

A primary object of the present invention is to provide a diamond cutting method for not only increasing the quantity of facets, but also perfecting the relative angles, size and arrangement of such facets, therefore, the diamond prepared in present invention will be observed with improved brilliancy and ray dispersion.

Another object of the present invention is to provide a diamond cutting method for increasing facets on the pavilion portion of the diamond, namely 3-5 sets of facets on the pavilion portion, wherein the newly added facets are harmonized with crown portion facets so as to reinforce the internal flickering, ray dispersion and overall brilliance of the diamond.

Accordingly, to achieve above object, the present invention provides a cutting method for cutting at least 3-5 set of pavilion facets for substantially exhibiting the flickering, dispersion and brilliancy of the diamond.

These and other objectives, features, and advantages of the present invention will become apparent from the following detailed description, the accompanying drawings, and the appended claims.

### BRIEF DESCRIPTION OF THE DRAWINGS

FIG. 1 is a top view of a standard 57 facets round brilliant-cut diamond.

FIG. 2 is a side view of a standard 57 facets round brilliant-cut diamond.

FIG. 3 is a bottom view of a standard 57 facets round brilliant-cut diamond.

FIG. 4 is a side view of a round brilliant-cut diamond according to a preferred embodiment of the present invention.

FIG. 5 is a bottom view of above round brilliant-cut diamond according to the preferred embodiment of the present invention.

FIG. 6 is a side view of above round brilliant-cut diamond according to a second embodiment of the present invention.

FIG. 7 is a bottom view of above round brilliant-cut diamond according to the second embodiment of the present invention.

FIG. 8 is a side view of above round brilliant-cut diamond according to a third embodiment of the present invention.

FIG. 9 is a bottom view of above round brilliant-cut diamond according to the third embodiment of the present invention.

FIG. 10 is a side view of above round brilliant-cut diamond according to a fourth embodiment of the present invention.

FIG. 11 is a bottom view of above round brilliant-cut diamond according to the fourth embodiment of the present invention.

### DETAILED DESCRIPTION OF THE PREFERRED EMBODIMENT

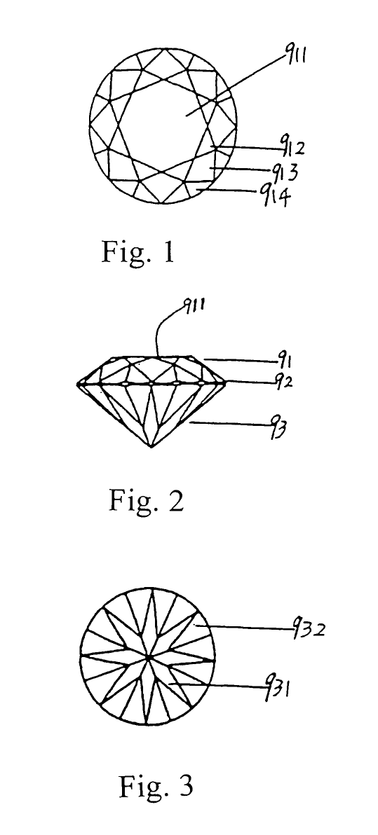

As shown in FIG. 1, FIG. 2, and FIG. 3, a conventional standard round brilliant-cut diamond is illustrated, wherein the diamond comprises a crown portion 91 having an octagonal table facet 911, eight first facets 912, eight second facets 913, and sixteen third facets 914, and a pavilion portion 92 having eight fourth facets 931 and sixteen fifth facets 932.

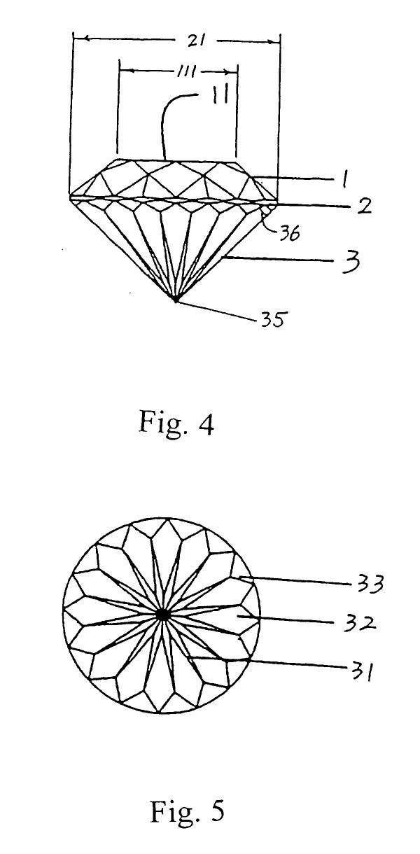

Referring to FIG. 4 and FIG. 5, a round brilliant-cut diamond according to a preferred embodiment of the present invention is illustrated, wherein the diamond comprises a crown portion 1, a girdle portion 2 and a pavilion portion 3. Like conventional 57 facets diamond, the crown portion 1 is consisted of three sets of facets, namely, eight first facets 12, eight second facets 13 and sixteen third facets 14. According to the preferred embodiment of the present invention, the width of the table facet 11 of the crown portion is proportionally sized with respect to the diameter of the girdle portion 2, wherein the size ration is ranged from 0.56 to 0.58. The lengths of the first facet 11 and the second facet 12 are prepared with a same size. The pavilion portion 3 comprises sixteen quadrangle shaped fourth facets 31, sixteen quadrangle shaped fifth facets 32, and sixteen sub-triangle shaped sixth facets 33, wherein the sixteen fourth facets 31 are merged into a bottom peak point 35, each of the correspondingly grouped fourth facet 31, fifth facet 32 and sixth facet 33 is also merged into a joint point. Preferably, the pavilion angle 36 of the pavilion portion 3 is defined within a range between 40.8° and 41.5°. Furthermore, the length ratio between the sixth facet and the fifth facet is around 0.25.

The present invention further provides a corresponding method for cutting the diamond of above preferred embodiment. First of all, the crown portion 1 is cut to define a table facet 11, a plurality of first facets 12, a plurality of second facets 13, and a plurality of third facets 14. Afterwards, the upper edge 36 of the pavilion portion 3 is cut to define sixteen fourth facets 31. After then, each of the included angles between neighboring fourth facets 31 is cut to define sixteen fifth facets 32; finally, each of the included angle between neighboring fifth facets 32 at a position adjacent to the girdle portion 2 is cut to define sixteen facets 33.

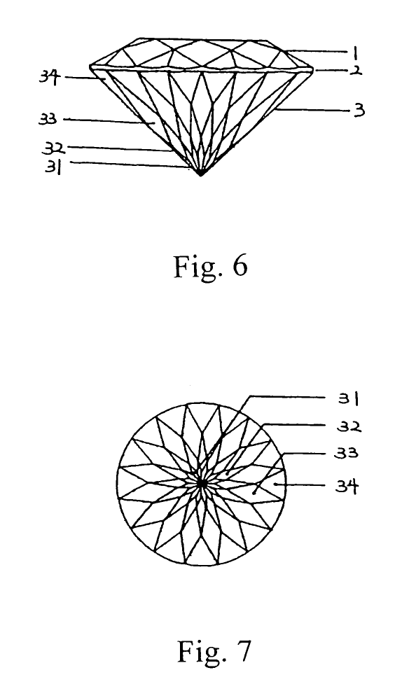

Referring to FIG. 6 and FIG. 7, the round brilliant-cut diamond prepared according to a second preferred embodiment of the present invention is illustrated. The pavilion 3 comprise sixteen quadrangle shaped fourth facets 31, sixteen quadrangle shaped fifth facets 32, sixteen quadrangle sixth facets 33, and sixteen sub-sector shaped seventh facets 34, wherein the fourth facets 31 are merged into a bottom peak, each of the correspondingly grouped fourth facet 31, fifth facet 32 and sixth facet 33 is also merged into a joint point. Preferably, the fourth facet 31 is prepared with a diamond shape. It is noted that a pair of short side edges of the fifth facets 32 are embodied as side edges of neighboring fourth facets 31. Meanwhile, the remaining two long side edges of the fifth facets 32 are sized twice as the length of the side edges of the fourth facets 31. And the pavilion angle of the pavilion portion 3 is defined within a range between 40.8° and 41.5°. Furthermore, the length ratio between the table facet width and the diameter of the girdle portion is around 0.56.

Accordingly, the present invention further provides a corresponding method for cutting the diamond of above second preferred embodiment. First of all, the crown portion 1 is cut to define a table facet 11, a plurality of first facets 12, a plurality of second facets 13, and a plurality of third facets 14. Afterwards, the upper edge 36 of the pavilion portion 3 is cut to define sixteen fourth facets 31. After then, each of the included angles between neighboring fourth facets 31 is cut to define sixteen fifth facets 32; and each of the included angles between neighboring fifth facets 31 is cut to define sixteen sixth facets 33. Finally, each of the included angles between neighboring sixth facets 33 at a position adjacent to the girdle portion 2 is cut to define sixteen sub-diamond shaped seventh facets 34.

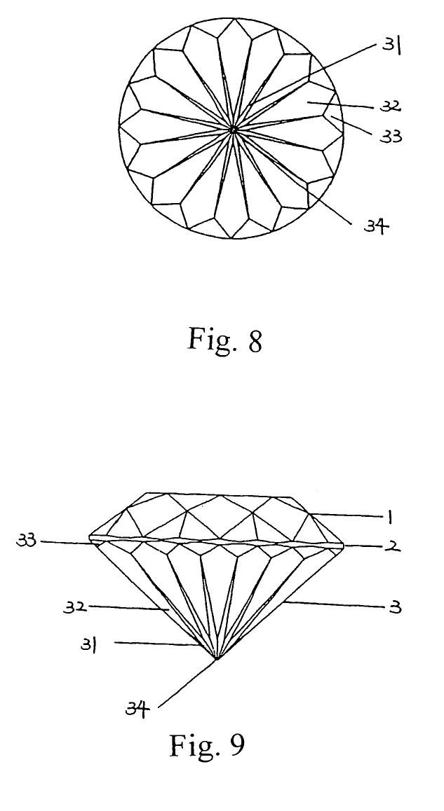

Referring to FIG. 8 and FIG. 9, the round brilliant-cut diamond prepared according to a third preferred embodiment of the present invention is illustrated. The pavilion 3 comprise sixteen quadrangle shaped fourth facets 31, sixteen quadrangle shaped fifth facets 32, sixteen quadrangle sixth facets 33, and a seventh facet 34 defined at the bottom side thereof, wherein the fourth facet 31 and the seventh facet 34 share a common side edge, each of the correspondingly grouped fourth facet 31, fifth facet 32 and sixth facet 33 is also merged into a joint point. And more importantly, the bottom seventh facet 34 is paralleled with the table facet 11 of the crown portion 1.

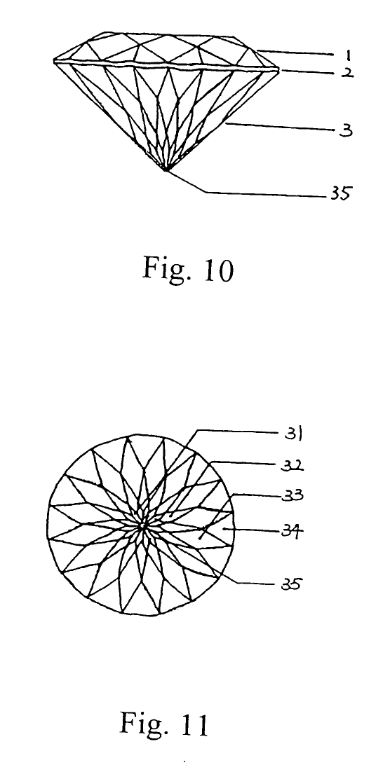

Or otherwise, referring to FIG. 10 and FIG. 11, the round brilliant-cut diamond prepared according to a fourth preferred embodiment of the present invention is illustrated. The pavilion 3 comprise sixteen quadrangle shaped fourth facets 31, sixteen quadrangle shaped fifth facets 32, sixteen quadrangle sixth facets 33, sixteen sub-sector shaped seventh facets 34, and a eighth facet defined at the bottom side thereof, wherein the fourth facet 31 and the seventh facet 34 share a common side edge, each of the correspondingly grouped fourth facet 31, fifth facet 32 and sixth facet 33 is also merged into a joint point, each of the correspondingly grouped fifth facet 32, sixth facet 33 and seventh facet 34 is merged into a joint point. And preferably, the bottom eighth facet 35 is paralleled with the table facet 11 of the crown portion 1.

Regarding to the present invention, the brilliant-cut diamond substantially increases its facets that the total number of facets of the brilliant-cut diamond can be increased to 81, 82, 97, or 98. The array and the size of each of the facets can be selectively adjusted with respect to the diamond in ratio. Accordingly, by increasing the number of facets, the diamond enhances the internal flickering and ray dispersion and increases the value of the diamond.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

1. A round brilliant-cut diamond, comprising:
a crown portion having a squared octagonal table facet, eight first facets, eight second facets and sixteen third facets cut thereon;
a girdle portion; and
a pavilion portion having sixteen quadrangle shaped fourth facets, sixteen quadrangle shaped fifth facets, sixteen sub-triangle sixth facets cut thereon, wherein said fourth facets are merged into a bottom peak, each of said fourth facets, said fifth facets and said sixth facets are grouped with each other to share a meet point.

2. The round brilliant-cut diamond, as recited in claim 1, wherein a length ratio between said sixth facet and said fifth facet is around 0.25.

3. The round brilliant-cut diamond, as recited in claim 1, wherein said first facet and said third facet share a same length.

4. The round brilliant-cut diamond, as recited in claim 1, wherein said pavilion portion has a pavilion angle being defined within a range between 40.8° and 41.5°.

5. The round brilliant-cut diamond, as recited in claim 1, wherein a length ratio between a width of said table facet and a diameter of said girdle portion is around 0.5.

6. A round brilliant-cut diamond, comprising:
a crown portion having a squared octagonal table facet, eight first facets, eight second facets, sixteen third facets cut thereon;
a girdle portion; and
a pavilion portion having sixteen quadrangle fourth facets, sixteen quadrangle fifth facets, sixteen quadrangle sixth facets, and sixteen sub-sector seventh facets cut thereon, wherein said fourth facets are merged into a bottom peak, each of said fourth facets, said fifth facets and said sixth facets are grouped with each other to share a meet point, each of said fifth facets, said sixth facets and seventh facets are grouped with each other to share a meet point.

7. The round brilliant-cut diamond, as recited in claim 6, wherein said fourth facet is diamond shaped.

8. The round brilliant-cut diamond, as recited in claim 6, wherein said fifth facet has a pair of short side edges respectively embodied as side edges of neighboring said fourth facets, and another pair of long side edges sized twice as a length of said side edges of said fourth facets.

9. The round brilliant-cut diamond, as recited in claim 6, wherein said pavilion portion has a pavilion angle being defined within a range between a range between 40.8° and 41.5°.

10. The round brilliant-cut diamond, as recited in claim 6, wherein a length ratio between said table facet width and a diameter of said girdle portion is around 0.56.

11. A round brilliant-cut diamond, comprising:
a crown portion having a squared octagonal table facet, eight first facets, eight second facets, sixteen third facets cut thereon;
a girdle portion; and
a pavilion portion having sixteen quadrangle fourth facets, sixteen quadrangle fifth facets, sixteen sub-triangle sixth facets, wherein a bottom side of said pavilion is cut to form a seventh facet, wherein each of said fourth facet is correspondingly shared with a side edge of said seventh facet, wherein each of said fourth facets, said fifth facets and said sixth facets are grouped with each other to share a meet point.

12. The round brilliant-cut diamond, as recited in claim 11, wherein said seventh facet is parallel to said table facet.

13. A round brilliant-cut diamond, having:
a crown portion having a squared octagonal table facet, eight first facets, eight second facets and sixteen third facets cut thereon;
a girdle portion; and
a pavilion portion having sixteen quadrangle shaped fourth facets, sixteen quadrangle shaped fifth facets, sixteen quadrangle sixth facets, and sixteen sub-sector seventh facets cut thereon, wherein a bottom side of said pavilion is cut to form an eighth facet, wherein each of said fourth facets and said eighth facet share with a common edge, wherein said fourth facets, said fifth facets, and said sixth facets extend to meet at a meet point, wherein said fifth facets, said sixth facets, and said seventh facets extend to meet at another meet point.

14. The round brilliant-cut diamond, as recited in claim 13, wherein said bottom eighth facet is parallel with said table facet.

15. The round brilliant-cut diamond, as recited in claim 1, is prepared by following steps:
a. cutting said crown portion to define a table facet, a plurality of first facets, a plurality of second facets and a plurality of third facets;
b. cutting an upper edge of said pavilion portion to define sixteen fourth facets;
c. cutting each of included angles between neighboring said fourth facets to define sixteen fifth facets; and
d. cutting each of included angles between neighboring said fifth facets at a position adjacent to said girdle portion so as to define sixteen sixth facets.

16. The round brilliant-cut diamond, as recited in claim 6, is prepared by following steps:
a. cutting said crown portion to define a table facet, a plurality of first facets, a plurality of second facets and a plurality of third facets;
b. cutting an upper edge of said pavilion portion to define sixteen fourth facets;
c. cutting each of included angles between neighboring said fourth facets to define sixteen fifth facets;
d. cutting each of included angles between neighboring said fifth facets to define sixteen sixth facets; and
e. cutting each of included angles between neighboring said fifth facets at a position adjacent to said girdle portion so as to define sixteen sub-sector shaped seventh facets.
